(19) United States
(12) Patent Application Publication
(10) Pub. No.: US 2025/0061113 A1
(43) Pub. Date: Feb. 20, 2025

(54) MONITORING QUERY PROCESSING TRENDS IN A DATABASE SERVER TO IDENTIFY PERIODS OF ANTICIPATED HIGH DEMAND

(71) Applicant: International Business Machines Corporation, Armonk, NY (US)

(72) Inventors: Binoy Thomas, Kozhikode (IN); Sudheesh S. Kairali, Kozhikode (IN); Abhishek Jain, Baraut (IN); Sarbajit K. Rakshit, Kolkata (IN)

(21) Appl. No.: 18/451,877

(22) Filed: Aug. 18, 2023

(51) Int. Cl. G06F 16/2453

(52) U.S. Cl. CPC G06F 16/24549

(57) ABSTRACT

Computer-implemented methods for identifying query processing trends are provided. Aspects include receiving a plurality of queries, providing a response to each of the plurality of queries, and receiving client resource utilization information associated with processing the response. Aspects also include identifying one or more of the plurality of queries as periodically repeated queries and a trend of the client resource utilization information. Aspects further include determining a period of anticipated high demand on the database server based on the periodically repeated queries and the trend of the resource utilization information and broadcasting, by a database server to each of a plurality of clients, an indication of the period of anticipated high demand on the database server.

### BACKGROUND

The present disclosure generally relates to monitoring query processing trends, and more specifically, to methods and systems for methods for monitoring query processing trends in a database server to identify periods of anticipated high demand.

Database servers and distributed database servers are utilized by many organizations to collect and store data generated by various parts of their organizations, such as sales data, production data, and the like. These database servers are frequently queried to obtain data regarding the operation of the organization for reporting, performing analytics, forecasting, and the like. Often, such queries are scheduled queries that are automatically performed on a recurring basis. As the number of these scheduled queries grow, the load on the database server increases and the response time of the database server may decrease.

### SUMMARY

Embodiments of the present disclosure are directed to computer-implemented methods for monitoring query processing trends in a database server to identify periods of anticipated high demand. According to an aspect, a computer-implemented method includes receiving a plurality of queries, providing a response to each of the plurality of queries, and receiving client resource utilization information associated with processing the response. The method also includes identifying one or more of the plurality of queries as periodically repeated queries and a trend of the client resource utilization information. The method further includes determining a period of anticipated high demand on the database server based on the periodically repeated queries and the trend of the resource utilization information and broadcasting, by a database server to each of a plurality of clients, an indication of the period of anticipated high demand on the database server.

Embodiments also include computer systems and computer program products for monitoring query processing trends in a database server to identify periods of anticipated high demand.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for monitoring query processing trends in a database server to identify periods of anticipated high demand in accordance with one or more embodiments of the present disclosure;

FIG. 3 depicts a flowchart of a method for processing a query and obtaining client resource utilization data in accordance with one or more embodiments of the present disclosure;

FIG. 4 depicts a flowchart of a method for identifying periods of anticipated high demand for a database server in accordance with one or more embodiments of the present disclosure;

FIG. 5 depicts a flowchart of a method for providing client resource utilization data to a database server in accordance with one or more embodiments of the present disclosure; and

FIG. 6 depicts a flowchart of a method for managing scheduled queries based on database server demand in accordance with one or more embodiments of the present disclosure.

### DETAILED DESCRIPTION

As discussed above, as the number of scheduled queries performed by a database server grow, the load on the database server increases and the performance and response time of the database server may decrease. Exemplary embodiments include methods, systems, and computer program products for monitoring query processing trends in a database server to identify periods of anticipated high demand. In exemplary embodiments, the database server is configured to identify periodically repeated queries and to identify growth trends related to the periodically repeated queries. The database server is further configured to analyze the identified periodically repeated queries and their related growth trends to predict the occurrence and size of future queries. In exemplary embodiments, the database server is configured to determine a period of anticipated high demand based on the identified periodically repeated queries and the trend information. The database server transmits an indication of the period of anticipated high demand to clients that provide queries to the database server. In exemplary embodiments, one or more of the clients are configured to reschedule one or more scheduled queries to reduce the load on the database server during the period of anticipated high demand.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as monitoring query processing trends in a database server to identify periods of anticipated high demand (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

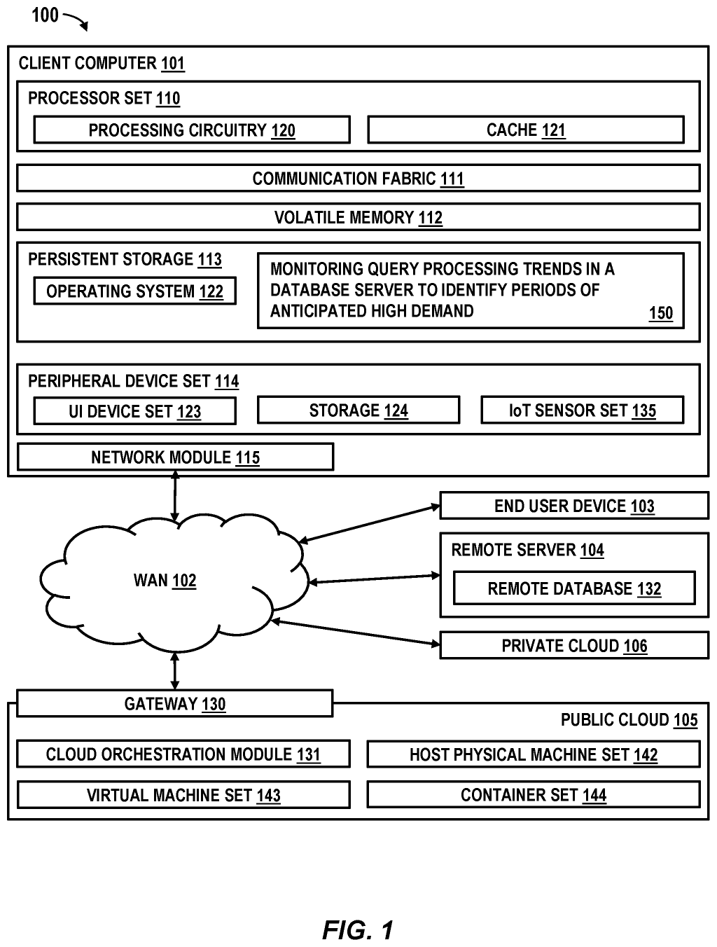

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

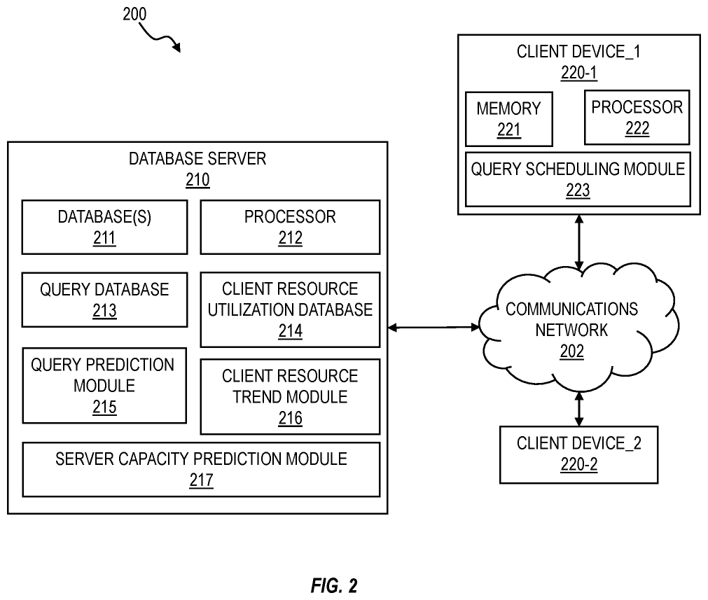

Referring now to FIG. 2, a block diagram of a system 200 for monitoring query processing trends in a database server to identify periods of anticipated high demand in accordance with one or more embodiments of the present disclosure is shown. As illustrated, the system 200 includes at least two client devices 220-1 and 220-2, referred to collectively as client devices 220. In exemplary embodiments, each client device 220 is embodied in a computer 101, such as the one shown in FIG. 1. The client devices 220 are each connected to a communications network 202 and communicate with a database server 210 via the communications network 202. The communications network 202 may include one or more public and private communications networks, such the Internet.

In exemplary embodiments, each client device 220 includes a memory 221, a processor 222 and a query scheduling module 223. In exemplary embodiments, one or more of the client devices 220 are query engines that are configured to query the database server 210. In one embodiment, the client devices 220 include query scheduling modules 223 that are configured to automatically perform one or more queries on a periodic basis. For example, a first client device 220 may have a query scheduling module 223 that is configured to perform one or more of a first query every day at a specified time, a second query once a week at a specified day and time, and a third query every hour. In exemplary embodiments, the queries and the frequency in which the queries are performed are set by a user of the client device 220. In one embodiment, each query has an associated importance level that is also set by a user of the client device 220.

In exemplary embodiments, the client device 220 are configured to transmit queries to the database server 210 and to utilize the memory 221 and processor 222 to process the response to the query provided by the database server 210. The client devices 220 are configured to monitor the utilization of the memory 221 and the processor 222 during the processing of the response to the query provided by the database server 210 and to provide the utilization data to the database server 210.

In exemplary embodiments, the database server 210 includes one or more databases 211, a processor 212, a query database 213, a client resource utilization database 214, a query prediction module 215, a client resource trend module 216, and a server capacity prediction module 217. In exemplary embodiments, the processor 212 is configured to execute received queries on the one or more databases 211 and to transmit a response to the query to a corresponding client device 220.

In exemplary embodiments, the database server 210 is configured to store a record of each received query in the query database 213 along with the date/time that the query was received, an identification of the client device that transmitted the query, and a size of the data records that were included in the response to the query. In exemplary embodiments, the client resource utilization database 214 is configured to store client resource utilization data received from a client device. Each entry in the client resource utilization database includes an identification of the client device, an identification of a query, a memory utilization, and a processor utilization of the client device while the client device was processing the response to the query.

In exemplary embodiments, the query prediction module 215 is configured to analyze the data stored in the query database 213 and to identify one or more periodically repeated queries. For example, the query prediction module 215 may analyze the data stored in the query database 213 and identify that first client device transmits the same query every day at a specific time. Based on the identification of the periodically repeated queries, the query prediction module 215 is further configured to predict anticipated queries from various client devices 220. In one embodiment, the predicted anticipated queries include a predicted date/time that the query will be received, an identification of the client device that will transmit the query, and an estimated size of the data records that will be included in the response to the query. In exemplary embodiments, the processor 212 of the database server is configured to monitor incoming queries and to determine whether incoming queries match the anticipated queries. Further, the processor 212 is configured to maintain an accuracy rate for the query prediction module 215 based on its performance in predicting future queries.

In exemplary embodiments, the client resource trend module 216 is configured to analyze the data stored in the client resource utilization database 214 and to identify a trend, i.e., a pattern of change over time, for the resource utilization of one or more client device. For example, the client resource trend module 216 may identify that a first client device has a trend of increasing memory utilization and processor utilization of five percent per month. In exemplary embodiments, an identified trend of the resource utilization for each of a client device is indicative underlying change in the dataset obtained by the query. For example, a weekly query is configured to obtain transactional data for a business for a previous week. In this case, the identified trend data can be used to identify that the number of transactions is growing or shrinking at an identified rate.

In exemplary embodiments, the server capacity prediction module 217 is configured to determine a period of anticipated high demand on the database server. In one embodiment, the period of anticipated high demand on the database server is determined based on one or more of the anticipated queries obtained from the query prediction module 215 and the trend of the resource utilization for each of the plurality of clients obtained from the client resource trend module 216. For example, the server capacity prediction module 217 can combine the information about the anticipated queries and client resource utilization trends to approximate how busy the database server 210 will be during any particular point in time. In one embodiment, the server capacity prediction module 217 is configured to identify a predicted utilization rate of the processor 212 based on the predicted queries and the trend of the resource utilization for each of the plurality of clients.

In exemplary embodiments, an administrator of the database server 210 can set a threshold value that is used to determine the cutoff for a high demand period. For example, the administrator may set a threshold of forty percent as the threshold value when approximately half of the queries received by the database server 210 are periodically repeated queries. In another example, the administrator may set a threshold of eighty percent as the threshold value when most of the queries received by the database server 210 are periodically repeated queries. In exemplary embodiments, the server capacity prediction module 217 is further configured to broadcast an indication of an anticipated high demand on the database server or high resource utilisation on the client to each of the plurality of clients. In response to this indication, one or more of the client devices may adjust their scheduled queries.

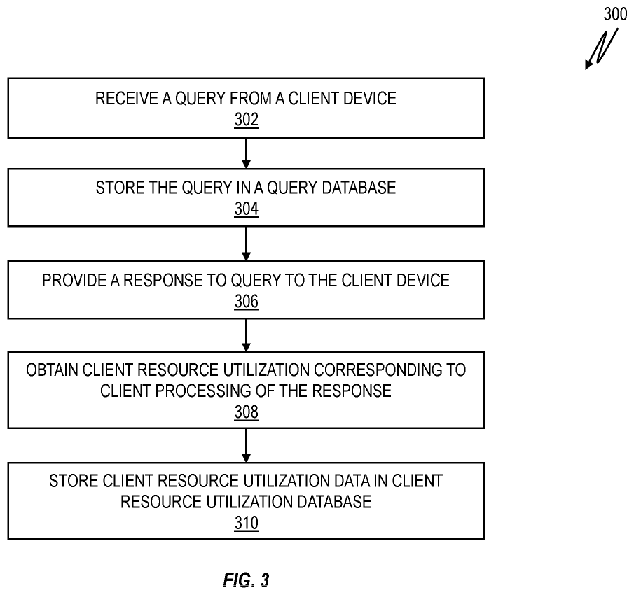

Referring now to FIG. 3, a flowchart of a method for processing a query and obtaining client resource utilization data in accordance with one or more embodiments of the present disclosure is shown. In one embodiment, the method 300 is performed by a database server 210 such as the one shown in FIG. 2. At block 302, the method 300 includes receiving a query from a client device. Next, as shown at block 304, the method 300 includes storing the query in a query database. In exemplary embodiments, the query database includes the query, the date/time that the query was received, an identification of the client device that transmitted the query, and a size of the data records that were included in the response to the query. At block 306, the method 300 includes providing a response to the query to the client device. Next, as shown at block 308, the method 300 includes obtaining client device resource utilization data corresponding the clients processing of the response to the query. In one embodiment, the client device resource utilization data includes both a memory utilization rate and a processor utilization rate of the client device during processing of the response to the query by the client device. The method 300 also includes storing the client resource utilization data in client resource utilization database, as shown at block 310.

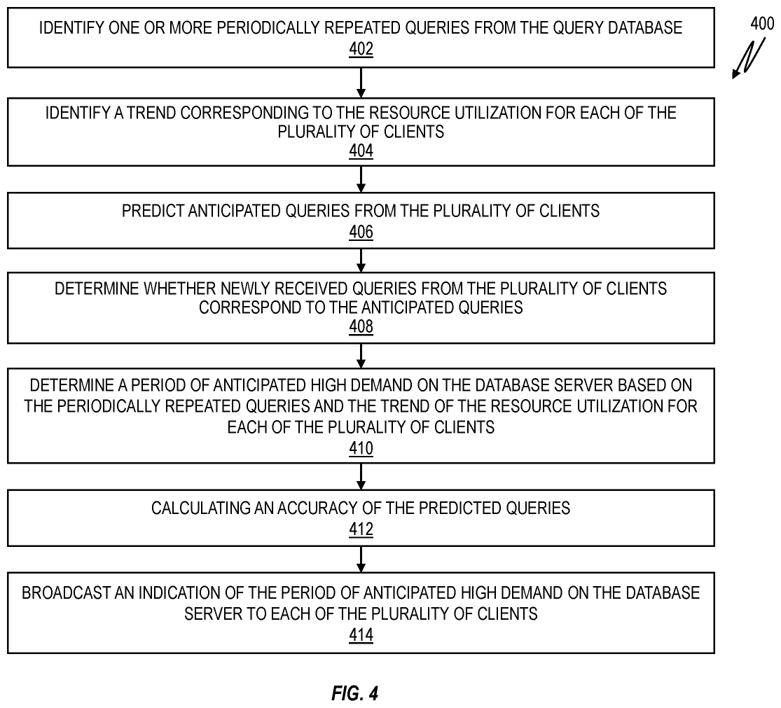

Referring now to FIG. 4, a flowchart of a method for identifying periods of anticipated high demand for a database server in accordance with one or more embodiments of the present disclosure is shown. In one embodiment, the method 400 is performed by a database server 210 such as the one shown in FIG. 2. At block 402, the method 400 includes identifying one or more periodically repeated queries from the query database. In exemplary embodiments, the one or more periodically repeated queries are identified by analyzing the data in the query database. Next, as shown at block 404, the method 400 includes identifying a trend corresponding to the resource utilization for each of the plurality of clients. In exemplary embodiments, the trends corresponding to the resource utilization for each of the plurality of clients are identified by analyzing the data stored in the client resource utilization database. At block 406, the method includes predicting anticipated queries from the plurality of clients. In exemplary embodiments, the anticipated queries are predicted based on the identified periodically repeated queries.

At block 408, the method 400 includes determining whether newly received queries from the plurality of clients correspond to the anticipated queries. Next, at block 410, the method 400 includes determining a period of anticipated high demand on the database server based on the periodically repeated queries and the trend of the resource utilization for each of the plurality of clients. In exemplary embodiments, a period is considered to be a high demand period when the predicted workload on the database server exceeds a threshold level set by a database administrator. In exemplary embodiments, the threshold level may be based on the percentage queries received by the database server that are periodically repeated. At block 412, the method 400 includes calculating an accuracy of the predicted queries. The method 400 concludes at block 414 by broadcasting an indication of the period of anticipated high demand on the database server to each of the plurality of clients. In exemplary embodiments, the indication of the period of anticipated high demand is only broadcast to the plurality of clients based on a determination that the accuracy of the predicted queries is above a threshold amount, which may be set by a database administrator.

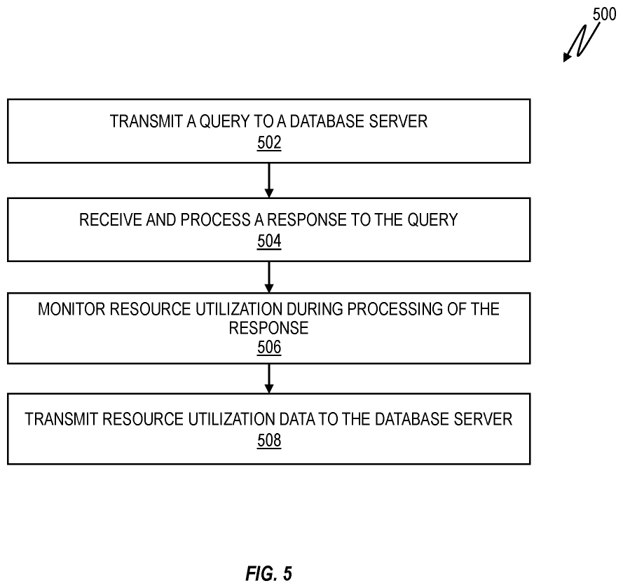

Referring now to FIG. 5, a flowchart of a method for providing client resource utilization data to a database server in accordance with one or more embodiments of the present disclosure is shown. In one embodiment, the method 500 is performed by a client device 220-1 such as the one shown in FIG. 2. At block 502, the method 500 includes transmitting a query to a database server. Next, as shown at block 504, the method 500 includes receiving and processing a response to the query. At block 506, the method 500 includes monitoring resource utilization during the processing of the response. In exemplary embodiments, the resource utilization includes a memory utilization rate and a processor utilization rate. The method 500 concludes at block 508 by transmitting the resource utilization data to the database server.

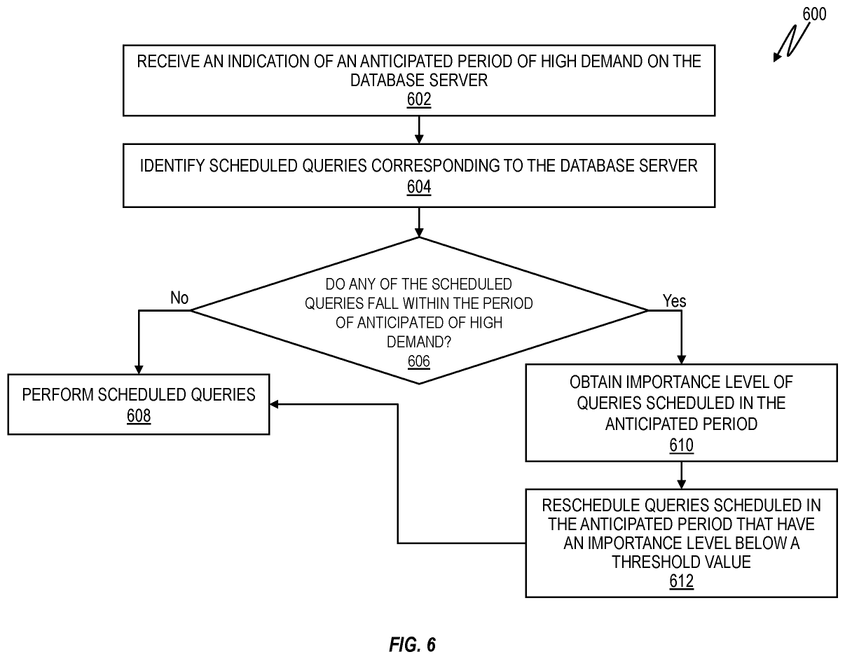

Referring now to FIG. 6, a flowchart of a method for managing scheduled queries based on database server demand in accordance with one or more embodiments of the present disclosure is shown. In one embodiment, the method 600 is performed by a client device 220-1 such as the one shown in FIG. 2. At block 602, the method 600 includes receiving an indication of an anticipated period of high demand on the database server. Next, as shown at block 604, the method 600 includes identifying scheduled queries corresponding to the database server. At decision block 606, the method includes determining whether any of the scheduled queries fall within the period of anticipated of high demand. If none of the scheduled queries fall within the period of anticipated of high demand, the method 600 proceed to block 608 and performs the scheduled queries. If one or more of the scheduled queries fall within the period of anticipated of high demand, the method 600 proceed to block 610 and the importance level of queries scheduled in the anticipated period are obtained. Next, at block 612, the method 600includes rescheduling queries scheduled in the anticipated period that have an importance level below a threshold value.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for identifying query processing trends, the method comprising:
receiving, by a database server, a plurality of queries, each of the plurality of queries being received from one of a plurality of clients;
providing, by the database server, a response to each of the plurality of queries to a corresponding one of the plurality of clients;
receiving, by the database server from each of the plurality of clients, resource utilization information associated with processing the response;
identifying, by the database server, one or more of the plurality of queries as periodically repeated queries;
identifying, by the database server, a trend of the resource utilization information for each of the plurality of clients;
determining, by the database server, a period of anticipated high demand on the database server based on the periodically repeated queries and the trend of the resource utilization information for each of the plurality of clients; and
broadcasting, by the database server to each of the plurality of clients, an indication of the period of anticipated high demand on the database server.

2. The method of claim 1, wherein the resource utilization information includes a memory utilization and a processor utilization during processing of the response.

3. The method of claim 2, wherein the trend of the resource utilization information for each of the plurality of clients indicates an observed change of the memory utilization and the processor utilization as a function of time.

4. The method of claim 1, wherein the periodically repeated queries include duplicate queries that are received from one of the plurality of clients at a regular interval.

5. The method of claim 1, wherein identifying one or more of the plurality of queries as the periodically repeated queries includes identifying a frequency of the periodically repeated queries.

6. The method of claim 1, further comprising:
predicting, by the database server, anticipated queries from the plurality of clients;
determining, by the database server, whether newly received queries from the plurality of clients correspond to the anticipated queries; and
calculating an accuracy of the predicting.

7. The method of claim 6, wherein the indication of the period of anticipated high demand on the database server is only broadcast based on the accuracy of the predicting exceeding a threshold level.

8. A computing system having a memory having computer readable instructions and one or more processors for executing the computer readable instructions, the computer readable instructions controlling the one or more processors to perform operations comprising:
receiving, by a database server, a plurality of queries, each of the plurality of queries being received from one of a plurality of clients;
providing, by the database server, a response to each of the plurality of queries to a corresponding one of the plurality of clients;
receiving, by the database server from each of the plurality of clients, resource utilization information associated with processing the response;
identifying, by the database server, one or more of the plurality of queries as periodically repeated queries;
identifying, by the database server, a trend of the resource utilization information for each of the plurality of clients;
determining, by the database server, a period of anticipated high demand on the database server based on the periodically repeated queries and the trend of the resource utilization information for each of the plurality of clients; and
broadcasting, by the database server to each of the plurality of clients, an indication of the period of anticipated high demand on the database server.

9. The computing system of claim 8, wherein the resource utilization information includes a memory utilization and a processor utilization during processing of the response.

10. The computing system of claim 9, wherein the trend of the resource utilization information for each of the plurality of clients indicates an observed change of the memory utilization and the processor utilization as a function of time.

11. The computing system of claim 8, wherein the periodically repeated queries include duplicate queries that are received from one of the plurality of clients at a regular interval.

12. The computing system of claim 8, wherein identifying one or more of the plurality of queries as the periodically repeated queries includes identifying a frequency of the periodically repeated queries.

13. The computing system of claim 8, wherein the operations further comprise:
predicting, by the database server, anticipated queries from the plurality of clients;
determining, by the database server, whether newly received queries from the plurality of clients correspond to the anticipated queries; and
calculating an accuracy of the predicting.

14. The computing system of claim 13, wherein the indication of the period of anticipated high demand on the database server is only broadcast based on the accuracy of the predicting exceeding a threshold level.

15. A computer program product comprising a computer readable storage medium having program instructions embodied therewith, the program instructions executable by a processor to cause the processor to perform operations comprising:
receiving, by a database server, a plurality of queries, each of the plurality of queries being received from one of a plurality of clients;
providing, by the database server, a response to each of the plurality of queries to a corresponding one of the plurality of clients;
receiving, by the database server from each of the plurality of clients, resource utilization information associated with processing the response;
identifying, by the database server, one or more of the plurality of queries as periodically repeated queries;
identifying, by the database server, a trend of the resource utilization information for each of the plurality of clients;
determining, by the database server, a period of anticipated high demand on the database server based on the periodically repeated queries and the trend of the resource utilization information for each of the plurality of clients; and
broadcasting, by the database server to each of the plurality of clients, an indication of the period of anticipated high demand on the database server.

16. The computer program product of claim 15, wherein the resource utilization information includes a memory utilization and a processor utilization during processing of the response.

17. The computer program product of claim 16, wherein the trend of the resource utilization information for each of the plurality of clients indicates an observed change of the memory utilization and the processor utilization as a function of time.

18. The computer program product of claim 15, wherein the periodically repeated queries include duplicate queries that are received from one of the plurality of clients at a regular interval.

19. The computer program product of claim 15, wherein identifying one or more of the plurality of queries as the periodically repeated queries includes identifying a frequency of the periodically repeated queries.

20. The computer program product of claim 15, wherein the operations further comprise:
predicting, by the database server, anticipated queries from the plurality of clients;
determining, by the database server, whether newly received queries from the plurality of clients correspond to the anticipated queries; and
calculating an accuracy of the predicting.
